(19) United States
(12) Patent Application Publication
(10) Pub. No.: US 2011/0039977 A1
(43) Pub. Date: Feb. 17, 2011

(54) AQUEOUS DISPERSIONS COMPRISING AT LEAST ONE ALKYD RESIN

(75) Inventors: Thorben Schuetz, Seeheim-Jugenheim (DE); Joachim Knebel, Alsbach-Haehnlein (DE); Mario Gomez, Pfungstadt (DE); Christine Maria Breiner, Laudenbach (DE); Matthias Beller, Nienhagen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/990,164

(22) PCT Filed: Apr. 23, 2009
(86) PCT No.: PCT/EP09/54862

§ 371 Date: Oct. 28, 2010

(30) Foreign Application Priority Data
Jun. 6, 2008 (DE) 10 2008 002 257.8

(51) Int. Cl. C08L 67/00; C08L 75/00

(52) U.S. Cl. 523/201; 524/502; 524/507; 524/513

(57) ABSTRACT

The present invention relates to an aqueous dispersion comprising at least one alkyd resin
and at least one polymer comprising repeating units derived from monomers A of formula (I)

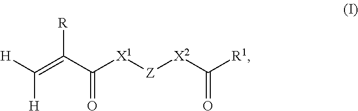

in which R is hydrogen or a methyl group, X¹ and X² independently are oxygen or a group of the formula NR′, in which R′ is hydrogen or a radical having 1 to 6 carbon atoms, with the proviso that at least one of the groups X¹ and X² is a group of the formula NR′ in which R′ is hydrogen or a radical having 1 to 6 carbon atoms, and Z is a linking group, and R¹ is an unsaturated radical having 9 to 25 carbon atoms.

The present invention relates to aqueous dispersions which feature at least one alkyd resin. The present invention further relates to processes for preparing these dispersions.

Coating materials, more particularly paints and varnishes, have for a long time been prepared synthetically. Many of these coating materials are based on what are called alkyd resins, which in general are prepared using polyfunctional acids, alcohols and fatty acids and/or fatty acid derivatives. One particular group of these alkyd resins form crosslinked films on exposure to oxygen, the crosslinking taking place by oxidation with involvement of unsaturated groups. Many of these alkyd resins comprise organic solvents or dispersion media to allow the resins to be applied in a thin film to coating elements. The use of these solvents ought, however, to be abandoned on grounds of environmental protection and of occupational safety. Corresponding resins have therefore been developed based on aqueous dispersions, but their stability on storage is limited. Furthermore, the properties of many alkyd resins are less than optimum. For instance, the water absorption is often too high. For many applications, furthermore, the solvent resistance or the hardness is too low.

Attempts have been undertaken, accordingly, to replace the conventional, alkyd-based coating materials outlined above. A coating composition based on solution polymers based on vinyl monomers, for example, is described in DE-A-101 06 561. That composition, however, includes a high fraction of organic solvents.

Also known, moreover, are aqueous dispersions based on (meth)acrylate polymers. For example, the publication DE-A-41 05 134 describes aqueous dispersions which can be used as binders in coating materials. The preparation of those binders, however, takes place over several stages, in which first a solution polymer is produced which, following neutralization, is used in an emulsion polymerization.

Furthermore, DE-A-25 13 516 describes aqueous dispersions comprising polymers based on (meth)acrylates, where some of the (meth)acrylates contain unsaturated alcohol residues. A particular disadvantage of the dispersions described is their costly and inconvenient preparation, the polymers being obtained on the basis of (meth)acrylates by solution polymerization. In that case these polymers have a high fraction of acid groups, in the range from 5% to 20% by weight, based on the solution polymer.

The publication DE-A-26 38 544 describes oxidatively drying aqueous dispersions which comprise emulsion polymers based on (meth)acrylates, with some of the (meth)acrylates used having unsaturated alcohol residues. However, chain transfer agents have been used to prepare the emulsion polymers, and so the solubility of the emulsion polymer is high.

Furthermore, aqueous dispersions comprising oxidatively drying polymers are set out in F.-B. Chen, G. Bufkin, “Crosslinkable Emulsion Polymers by Autooxidation II”, Journal of Applied Polymer Science, Vol. 30, 4551-4570 (1985). The polymers contain 2% to 8% by weight of units derived from (meth)acrylates having unsaturated, long-chain alcohol residues. These polymers, however, do not contain any units obtained by polymerization of monomers containing acid groups. For many applications the keeping properties of these dispersions and also the hardness of the coatings are inadequate.

Moreover, the publications U.S. Pat. No. 5,750,751, EP-A-1 044 993 and WO 2006/013061 describe coating materials comprising vinyl-monomer-based polymers which are able to crosslink at room temperature. The polymers can be obtained both by solution polymerization and by emulsion polymerization. The monomer mixtures for polymerization may comprise, among others, (meth)acrylates whose alcohol residues have been modified with unsaturated fatty acids. A disadvantage of the above-described coating materials that comprise polymers based on (meth)acrylates is their high price. Additionally, coatings obtained from the above-described coating materials frequently have a low hardness. There are no references in these documents to the use of these polymers in alkyd resins.

Furthermore, the Japanese publication JP 59011376 describes emulsion polymers based on (meth)acrylates. A disadvantage of the dispersions described in this publication is their low shelf life. Furthermore, it emerges that the coatings obtained do not have a stability sufficient for enhanced requirements in respect of all solvents.

Furthermore, U.S. Pat. No. 6,599,972 discloses coating compositions based on polymers that are based on (meth)acrylates whose alcohol residue is derived from unsaturated fatty acid derivatives. A disadvantage of the coating compositions set out explicitly therein is their shelf life and also the stability of the coatings obtainable from the compositions described.

The prior art, furthermore, has also disclosed dispersions which, as well as polymers based on (meth)acrylates, can also comprise alkyd resins. The document WO 98/22545, for example, describes polymers with units derived from (meth)acrylates having unsaturated alcohol residues. These polymers can be used together with alkyd resins. However, solvents are used in order to prepare coating materials from the polymers described. Aqueous dispersions are not described in WO 98/22545. Accordingly, these compositions are hampered by the disadvantages described above.

Moreover, U.S. Pat. No. 4,010,126 discloses compositions which comprise an alkyd resin which is modified with (meth)acrylate polymers and which is subsequently used in an emulsion polymerization. The compositions described are prepared over several steps, meaning that the preparation of the resins described is very costly and inconvenient.

Furthermore, the publication EP-A-0 267 562 describes dispersions which comprise modified alkyd resins. The alkyd resins are prepared using, more particularly, copolymers obtained by solution polymerization of (meth)acrylates and unsaturated fatty acids. In this case these fatty acids are incorporated into the copolymer via their double bonds. These resins are prepared over several steps, making use more particularly of large amounts of solvents. Furthermore, large amounts of ethylene glycol monobutyl ether are needed in order to obtain the dispersions. Similar dispersions are likewise described in DE-A-34 32 482, but have the same disadvantages as those set out in EP-A-0 267 562.

In addition, ER-A-1 578 864 discloses aqueous alkyd resins which have been modified with (meth)acrylate polymers. The (meth)acrylate polymers have been prepared using large amounts of unsaturated fatty acids. The complex preparation of these dispersions, however, is a disadvantage. Furthermore, the dispersions described lead to coatings whose hardness is relatively low.

In view of the prior art, then, it is an object of the present invention to provide coating materials and coatings with outstanding properties. More particularly the coating materials ought to have a very low residual monomer content. Additionally, therefore, it was an object of the present invention to provide a dispersion which has a particularly long storage life and shelf life. Furthermore, the intention was that the hardness of the coatings obtainable from coating materials could be varied over a wide range. In accordance with one particular aspect of the present invention, more particularly, it was intended that compositions be provided that lead to very hard, scratch-resistant coatings.

A further intention was that the coatings obtainable from the coating materials have a high solvent resistance. In this context this stability ought to be high with respect to many different solvents. A further object can be seen in the provision of coating materials without volatile organic solvents. The coatings obtainable from the aqueous dispersions ought to have a high weathering stability, more particularly a high UV stability. Furthermore, the films obtainable from the coating materials ought after a short time to feature a low tack. Moreover, the coating materials of the invention ought to be able to be prepared easily and inexpensively.

These objects and also others which, although not explicitly stated, are nevertheless readily inferable or derivable from the circumstances discussed in the introduction are achieved by aqueous dispersions having all of the features of Claim 1. Judicious modifications of the dispersions of the invention are protected in dependent claims. With regard to the preparation processes, Claims 24 and 25 provide a solution to the underlying objects.

The present invention accordingly provides an aqueous dispersion comprising at least one alkyd resin and

at least one polymer comprising repeating units derived from monomers A of formula (I)

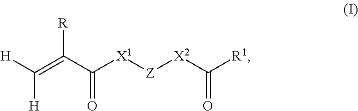

in which R is hydrogen or a methyl group, X¹ and X² independently are oxygen or a group of the formula NR′, in which R′ is hydrogen or a radical having 1 to 6 carbon atoms, with the proviso that at least one of the groups X¹ and X² is a group of the formula NR′ in which R′ is hydrogen or a radical having 1 to 6 carbon atoms, and Z is a linking group, and R¹ is an unsaturated radical having 9 to 25 carbon atoms.

Through the measures according to the invention it is additionally possible to obtain advantages including the following:

The dispersions of the invention have a very low residual monomer content.

The hardness of the coatings obtainable from dispersions of the invention can be varied over a wide range. Thus it is possible more particularly to obtain very hard, scratch-resistant coatings. The coatings obtainable from the dispersions of the invention exhibit a surprisingly high solvent resistance, which is manifested more particularly in tests with methyl isobutyl ketone (MIBK), ammonia solutions or ethanol. For instance, the coatings obtained exhibit an outstanding classification in the context more particularly of experiments in accordance with the DIN 68861-1 furniture test.

The dispersions of the invention preferably contain no volatile organic solvents. Furthermore, the dispersions of the invention exhibit a high level of storage stability, a long shelf life and very good storage properties. More particularly virtually no aggregate is formed.

The coatings obtainable from the aqueous dispersions exhibit a high weathering stability, more particularly a high UV stability. The films obtainable from the aqueous dispersions, furthermore, after a short time feature a low tack.

The dispersions of the invention can be prepared inexpensively on a large scale. The dispersions of the invention are eco-friendly and can be prepared and processed safely and without great cost and complexity. In this respect the dispersions of the invention exhibit a very high shear stability.

The aqueous dispersions of the invention comprise at least one alkyd resin. Alkyd resins have been known for a long time, the term referring generally to resins obtained by condensing polybasic carboxylic acids and polyhydric alcohols, these compounds generally being modified with long-chain alcohols (fatty alcohols), fatty acids or compounds containing fatty acid, fats or oils for example (DIN 55945; 1968). Alkyd resins are set out in, for example, Ullmann's Encyclopedia of Industrial Chemistry, 5th edition on CD-ROM. As well as these conventional alkyd resins it is also possible to use resins which have similar properties. These resins likewise feature a high level of groups derived from the long-chain alcohols (fatty alcohols), fatty acids and compounds containing fatty acid, fats or oils for example, that were set out above. These derivatives, however, do not necessarily contain polybasic carboxylic acids, but may instead be obtained, for example, by reacting polyols with isocyanates. The alkyd resins that can be used can be preferably diluted or mixed with water.

Preferred polybasic carboxylic acids for preparing the alkyd resins whose use is preferred in the dispersion of the invention include dicarboxylic and tricarboxylic acids, such as phthalic acid, isophthalic acid, 5-(sodium sulpho)isophthalic acid, terephthalic acid, trimellitic acid, 1,4-cyclohexanedicarboxylic acid, butanedioic acid, maleic acid, fumaric acid, sebacic acid, adipic acid and azelaic acid, for example. These acids can also be used as anhydrides for the preparation. Particular preference is given to using aromatic dicarboxylic acids to prepare the alkyd resins. The fraction of polybasic carboxylic acids is preferably in the range from 2% to 50%, more preferably 5% to 40%, by weight, based on the weight of the reactants used in the reaction mixture for the preparation of the resin.

Also used for preparing the alkyd resins are polyhydric alcohols. These alcohols include, among others, trimethylolpropane, pentaerythritol, dipentaerythritol, trimethylolethane, neopentyl glycol, ethylene glycol, 1,3-butanediol, 1,4-butanediol, 1,6-hexanediol, 1,4-cyclohexyldimethanol, diethylene glycol, triethylene glycol, polyethylene glycol, polytetrahydrofuran, polycaprolactonediol, polycaprolactonetriol, trimethylol monoallyl ether, trimethylol diallyl ether, pentaerythritol triallyl ether, pentaerythritol diallyl ether, pentaerythritol monoallyl ether, 2-ethyl-2-(hydroxymethyl)-1,3-propanediol, 2-methyl-1,3-propanediol, 2,2,4-trimethylpentanediol, 2,2,4-trimethyl-1,3-pentanediol, 2,2′-bis(4-hydroxycyclohexyl)propane (hydrogenated bisphenol A), propylene glycol, dipropylene glycol, polypropylene glycol, glycerol and sorbitol. Of these, more particular preference is given to trimethylolethane, trimethylolpropane, pentaerythritol and sorbitol. In accordance with one particular aspect, more particular preference is given to alcohols having three or more hydroxy groups. The fraction of polyhydric alcohols is preferably in the range from 2% to 50%, more preferably 5% to 40%, by weight, based on the weight of the reactants used in the reaction mixture for the preparation of the resin.

Furthermore it is possible more particularly to use fatty acids for preparing the alkyd resins set out above. In this context it is possible more particularly to use saturated and unsaturated fatty acids, more particular preference being given to mixtures which comprise unsaturated fatty acids. Preferred fatty acids have 6 to 30, more preferably 10 to 26 and very preferably 12 to 22 carbon atoms. The fraction of fatty acids is preferably in the range from 2% to 90%, more preferably 10% to 70%, by weight, based on the weight of the reactants used in the reaction mixture for the preparation of the resin.

The suitable saturated fatty acids include, among others, caprylic acid, capric acid, lauric acid, myristic acid, palmitic acid, margaric acid, arachidic acid, behenic acid, lignoceric acid, cerotinic acid, palmitoleic acid and stearic acid.

The preferred unsaturated fatty acids include, among others, undecylenic acid, palmitoleic acid, oleic acid, elaidic acid, vaccenic acid, icosenoic acid, cetoleic acid, erucic acid, nervonic acid, linoleic acid, linolenic acid, arachidonic acid, timnodonic acid, clupanodonic acid and/or cervonic acid.

Furthermore, the fatty acids set out above may also be used in the form of their esters, such as in the form of triglycerides, for example.

Furthermore, the alkyd resins set out above may have further components. These include, for example, monobasic carboxylic acids, monohydric alcohols, or compounds which lead to emulsifying groups in the resins, such as polyethylene oxides, for example. The alkyd resins, furthermore, may contain hydroxycarboxylic acids, such as 2-, 3- and 4-hydroxybenzoic acid, rizinoleic acid, dihydroxypropionic acid, dihydroxysuccinic acid, dihydroxybenzoic acid, 2,2-dimethylolacetic acid, 2,2-dimethylolpropionic acid, 2,2-dimethylolbutyric acid and 2,2-dimethylolpentanoic acid, for example.

Additionally it is also possible to use modified alkyd resins which have been modified with resins, more particularly rosin, with styrene polymers, with acrylic polymers, with epoxides, with urethanes, with polyamides and/or with silicones. These modifications are set out in places which include the patent literature set out above, and in Ullmann's Encyclopedia of Industrial Chemistry, 5th edition on CD-ROM. Through these embodiments it is possible to alter, more particularly, the initial drying, adhesive strength, weathering stability, storage properties, chemical resistance, through-curing, the stability of the wet film, and the abrasion resistance.

By way of example it is possible with preference to use alkyd resins which have been modified with polymers obtainable by free-radical addition polymerization. Resins of this kind are known from sources including the publications U.S. Pat. No. 5,538,760, U.S. Pat. No. 6,369,135 and DE-A-199 57 161. The resins set out in publication U.S. Pat. No. 5,538,760, filed on 22 May 1995 at the Patent Office of the United States of America (USPTO) with the application number U.S. Pat. No. 446,130, are incorporated, for the purposes of disclosure, into the present specification. The resins set out in publication U.S. Pat. No. 6,369,135 B1, filed on 13 Aug. 1996 at the Patent Office of the United States of America (USPTO) with the application Ser. No. 08/696,361, are incorporated, for the purposes of disclosure, into the present specification. The resins set out in publication DE-A-199 57 161, filed on 27 Nov. 1999 at the German Patent and Trade Mark Office with the application number DE 19957161.9, are incorporated, for the purposes of disclosure, into the present specification.

According to the publications U.S. Pat. No. 5,538,760 and U.S. Pat. No. 6,369,135, one of the ways in which modified alkyd resins can be obtained is to polymerize a monomer mixture in the presence of an alkyd resin. The weight ratio of monomer mixture to alkyd resin in this case is preferably in the range from 100:1 to 1:4, more preferably 5:1 to 1:1.

Particularly judicious resins include the acrylate-modified alkyd resins described in DE-A-199 57 161. These alkyd resins, in addition to an alkyd core, have groups which are obtained by polymerizing (meth)acrylates.

These acrylate-modified alkyd resins are preparable by first, in the presence of at least one water-miscible diol,
(1) dispersing at least one alkyd resin containing, based on its total amount, 0.1% to 10% by weight of pendent and/or terminal allyloxy groups in water to give the dispersion 1,
(2) graft-copolymerizing a mixture of methacrylic acid and at least one further, carboxyl-free olefinically unsaturated monomer in the dispersion 1, to give the dispersion 2, and
(3) once or n times
(3.1) graft-copolymerizing at least one acid-group-free, olefinically unsaturated monomer and/or
(3.2) graft-copolymerizing at least one mixture of at least one acid-group-containing, olefinically unsaturated monomer and at least one acid-group-free, olefinically unsaturated monomer in the dispersion 2 or 2 to n-1 that results from the respective preceding process step (2) or (2) to (n-1), with the proviso that, in process step (3) or its repetitions (3) to (n), acid groups are incorporated in an amount totalling not more than 90 mol% of the amount of acid groups incorporated in process step (2).

The pendent and/or terminal allyloxy groups set out above may be present in the alkyd resin in an amount, based in each case on the alkyd resin, of 0.1% to 10%, preferably 0.2% to 9%, more preferably 0.3% to 8%, with particular preference 0.4% to 7%, with very particular preference 0.5% to 6% and more particularly 0.6% to 5% by weight. The oxygen atom of the allyloxy group may be part of a urethane group, an ester group or an ether group that joins the allyl radical to the main chain of the alkyd resin.

Examples of suitable compounds for introducing pendent and/or terminal allyloxy groups are allyl alcohol, 2-hydroxyethyl allyl ether, 3-hydroxypropyl allyl ether, trimethylolpropane monoallyl or diallyl ether, glycerol monoallyl or diallyl ether, pentaerythritol monoallyl, diallyl or triallyl ether, mannitol monoallyl, diallyl, triallyl or tetraallyl ether, allyl esters of dihydroxypropionic, dihydroxysuccinic, dihydroxybenzoic, 2,2-dimethylolacetic, 2,2-dimethylolpropionic, 2,2-dimethylolbutyric or 2,2-dimethylolpentanoic acid, or allylurethane; of these, trimethylolpropane monoallyl ether is of advantage. For the modification of acrylates it is possible to graft-copolymerize dispersion 1 in one stage (2) with methacrylic acid and at least one further olefinically unsaturated monomer. Apart from their olefinically unsaturated double bonds, the further olefinically unsaturated monomers may additionally contain reactive functional groups with the exception of carboxyl groups, examples of the reactive functional groups being isocyanate-reactive, carbamate-reactive, N-methylol- or N-methylol ether-reactive or alkoxycarbonylamino-reactive groups. In this context it is essential that, under the given reaction conditions and the subsequent storage of the dispersions of the invention, these reactive functional groups do not enter into any reactions with the carboxyl groups of the methacrylic acid or with any other reactive functional groups present. One example of reactive functional groups that meet these requirements is the hydroxyl group. These monomers are known per se, examples being set out in DE 199 57 161. They include, more particularly, hydroxyalkyl esters of acrylic acid, of methacrylic acid or of another alpha,beta-olefinically unsaturated carboxylic acid, esters of acrylic acid, esters of methacrylic acid, of crotonic acid or of ethacrylic acid, having up to 20 carbon atoms in the alkyl radical.

Further preferred are alkyd resins obtainable in accordance with publication U.S. Pat. No. 5,096,959. The resins set out in publication U.S. Pat. No. 5,096,959 B1, filed on 30 Oct. 1990 at the Patent Office of the United States of America (USPTO) with the application number U.S. Pat. No. 609,024, are incorporated, for the purposes of disclosure, into the present specification. These alkyd resins are modified with cycloaliphatic polycarboxylic acid, with cyclohexanedicarboxylic acids and cyclopentanedicarboxylic acids being suitable more particularly for the modification.

It is possible, furthermore, to use alkyd resins which have been modified with polyethylene glycol. A large number of patent specifications describe the preparation of water-emulsifiable alkyd resins through modification with polyethylene glycol (PEG). In the majority of processes, about 10% to 30% of PEG are incorporated by transesterification or esterification directly into the alkyd resin (see, among others, the USA patent specifications U.S. Pat. Nos. 2,634,245; 2,853,459; 3,133,032; 3,223,659; 3,379,548; 3,437,615; 3,437,618; 10 3,442,835; 3,457,206; 3,639,315; the German Laid-Open specification 14 95 032; or the British patent specifications 1,038,696 and 1,044,821).

Preferred alkyd resins modified with polyethylene glycol include those known from the publication EP-A-0 029 145. The resins set out in publication EP-A-0 029 145, filed on 30 Oct. 1980 at the European Patent Office with the application number EP 80106672.1, are incorporated, for the purposes of disclosure, into the present specification. According to that publication it is possible first to react a polyethylene glycol with carboxylic acid containing epoxide groups. The resulting reaction product can then be used in the reaction mixture for preparing the alkyd resin. Preferred polyethylene glycols for modifying the alkyd resins have a number-average molecular weight of, for example, 500 to 5000 g/mol.

Particularly preferred polyethylene glycol-modified alkyd resins may be modified, furthermore, with copolymers which are obtainable by polymerizing methacrylic acid, unsaturated fatty acids, and vinyl and/or vinylidene compounds.

Also judicious are alkyd resins modified with urethane groups. Alkyd resins of this kind are set out in sources including WO 2006/092211 and EP-A-1 533 342.

In accordance with one judicious embodiment it is possible to use the urethane alkyd resins described in EP-A-1 533 342 that contain units derived from unsaturated fatty acids A1, aliphatic or aromatic or aromatic-aliphatic monocarboxylic acids A2 which are free from olefinic double bonds, cycloaliphatic dicarboxylic acids A3 or their anhydrides, at least trihydric, preferably at least tetrahydric, alcohols A4, and aromatic or aliphatic polyfunctional, more particularly difunctional, isocyanates A5. The urethane alkyd resin is prepared preferably in a two-stage reaction, in the first stage of which components A1 to A4 are esterified, the acid number of the product of the first stage being preferably not more than 10 mg/g, with particular preference not more than 5 mg/g. In the second stage, the hydroxyl-containing product from the first stage is reacted with the isocyanate A5, with addition of a small amount (up to 1% of the mass of the product of the first stage, preferably up to 0.5% of its mass) of a tertiary amine, in a reaction which entails molecular enlargement. Preferred urethane alkyd resins have a Staudinger index, measured in chloroform at 23° C., of at least 9 cm³/g, preferably at least 11 cm³/g.

The resins set out in publication EP-A-1 533 342, filed on 9 Nov. 2004 at the European Patent Office with the application number EP 04026511.8, are incorporated, for the purposes of disclosure, into the present specification.

With preference it is possible to use urethane alkyd resins which are obtainable by reacting polyhydric alcohols A′, modified fatty acids B′, fatty acids C′ and polyfunctional isocyanates D′. The modified fatty acids B′ can be prepared by reacting unsaturated fatty acids B1′ with unsaturated carboxylic acids B2′. These urethane alkyds are known from sources including WO 2006/092211. The resins set out in publication WO 2006/092211, filed on 20.02.06 at the European Patent Office with the application number PCT/EP2006/001503, are incorporated, for the purposes of disclosure, into the present specification. The modified fatty acid B′ preferably has an acid number of at least 80 mg/g. With particular preference the increase in the acid number as a result of the grafting is situated in the range from 80 mg/g to 250 mg/g, and with very particular preference in the range from 100 mg/g to 150 mg/g, the acid number being determinable in accordance with DIN EN ISO 2114. The iodine number of the fatty acids C′ used to prepare the urethane alkyd resins is preferably at least 80 g/100 g and more preferably at least 120 g/100 g. For preparing the urethane alkyd resin described in WO 2006/092211, generally speaking, first components A′, B′ and C′ are reacted, the condensate preferably having a 2S hydroxy functionality of at least 1.9, more preferably at least 2. The condensate may additionally contain groups derived from polybasic carboxylic acids, more particularly the dicarboxylic and tricarboxylic acids set out above. This condensate is subsequently reacted with a polyfunctional isocyanate. The preferred polyfunctional isocyanates include tolylene 2,4- and 2,6-diisocyanate and also their technical mixtures, bis(4-isocyanatophenyl)methane, isophorone diisocyanate, bis(4-isocyanatocyclohexyl)methane and 1,6-diisocyanatohexane, and the isocyanurates, allophanates and biurets derived from them.

Besides the conventional alkyd resins set out above and prepared using, generally, polycarboxylic acids, it is also possible to use further alkyd resins, as has already been set out above. Such further alkyd resins include, more particularly, urethane alkyd resins obtainable by reacting polyhydric alcohols with polyfunctional isocyanates, for example. Preferred urethane resins are known, for example, from EP-A-1 129 147. They can be obtained, for example, by reacting amide ester diols with polyols and polyfunctional isocyanates. The amide ester diols for use in accordance with EP-A-1 129 147 can be obtained by reacting vegetable oils with N,N-dialkanolamines.

In accordance with one preferred aspect of the present invention the alkyd resin may have an iodine number according to DIN 53241 of at least 1 g iodine/100 g, preferably of at least 10 g iodine/100 g, more preferably of at least 15 g iodine/100 g. In accordance with one particular aspect of the present invention the iodine number of the alkyd resin may be situated in the range from 2 to 100 g iodine per 100 g alkyd resin, more preferably 15 to 50 g iodine per 100 g alkyd resin. The iodine number may be determined from a dispersion, with the figure referring to the solids content.

Judiciously the alkyd resin may have an acid number in the range from 0.1 to 100 mg KOH/g, preferably 1 to 40 mg KOH/g and with very particular preference in the range from 2 to 10 mg KOH/g. The acid number may be determined in accordance with DIN EN ISO 2114 from a dispersion, the figure referring to the solids content.

The hydroxy number of the alkyd resin may be situated preferably in the range from 0 to 400 mg KOH/g, with particular preference 1 to 200 mg KOH/g and with very particular preference in the range from 3 to 150 mg KOH/g. The hydroxy number may be determined in accordance with DIN EN ISO 4629 from a dispersion, the figure referring to the solids content.

The preparation of the alkyd resins is very well established and is accomplished by condensing the alcohols and acids set out above, any modification being able to take place both during this condensation and after this condensation. In this context reference is made particularly to the literature set out above.

The aqueous dispersions of the invention further comprise at least one polymer comprising repeating units derived from monomers A of formula (I)

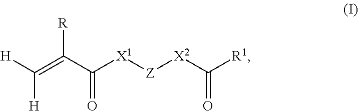

in which R is hydrogen or a methyl group, X¹ and X² independently are oxygen or a group of the formula NR′, in which R′ is hydrogen or a radical having 1 to 6 carbon atoms, with the proviso that at least one of the groups X¹ and X² is a group of the formula NR′ in which R′ is hydrogen or a radical having 1 to 6 carbon atoms, and Z is a linking group, and R¹ is an unsaturated radical having 9 to 25 carbon atoms.

The term polymer means that the dispersion comprises compounds which can be obtained by reacting monomers A with one another or with other monomers, this reaction being able to take place in one step or in stages. The polymer may comprise preferably at least 2, more preferably at least 5 and very preferably at least 10 repeating units, which may be derived from monomers A or comonomers. The upper limit on the number of repeating units is dependent on the nature of the reaction. In the case of emulsion polymerization it is even possible to obtain figures of more than 10⁷ repeating units. Accordingly, the term polymer must be understood comprehensively, since in the context of the invention it includes compounds which are often referred to as oligomers.

The dispersion may comprise one or more polymers which contain repeating units derived from monomers A. These polymers may differ, for example, in the fraction of monomer A or in the chain length, the solubility behaviour or other properties.

The polymer may be obtained preferably by free-radical addition polymerization. Accordingly the term “repeating unit” is a product of the monomers employed to prepare the polymer.

A dispersion of the invention comprises at least one polymer which has repeating units derived from monomer A of the general formula (I)

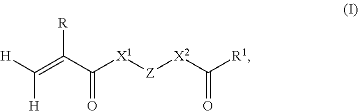

in which R is hydrogen or a methyl group, X¹ and X² independently are oxygen or a group of the formula NR′, in which R′ is hydrogen or a radical having 1 to 6 carbon atoms, with the proviso that at least one of the groups X¹ and X² is a group of the formula NR′ in which R′ is hydrogen or a radical having 1 to 6 carbon atoms, and Z is a linking group, and R¹ is an unsaturated radical having 9 to 25 carbon atoms.

According to one preferred embodiment at least some of the repeating units of the polymer are derived from monomers A of the general formula (III)

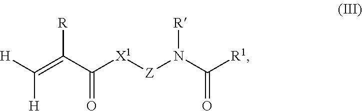

in which R is hydrogen or a methyl group, X¹ is oxygen or a group of the formula NR′, in which R′ is hydrogen or a radical having 1 to 6 carbon atoms, Z is a linking group, R′ is hydrogen or a radical having 1 to 6 carbon atoms, and R¹ is an unsaturated radical having 9 to 25 carbon atoms.

The expression “radical having 1 to 6 carbon atoms” stands for a group which contains 1 to 6 carbon atoms. It encompasses aromatic and heteroaromatic groups and also alkyl, cycloalkyl, alkoxy, cycloalkoxy, alkenyl, alkanoyl, alkoxycarbonyl groups and also heteroaliphatic groups. The stated groups may be branched or unbranched. Furthermore, these groups may contain substituents, especially halogen atoms or hydroxy groups.

Preferably the radicals R′ are alkyl groups. The preferred alkyl groups include the methyl, ethyl, propyl, isopropyl, 1-butyl, 2-butyl, 2-methylpropyl and tert-butyl groups.

The group Z stands preferably for a linking group which comprises 1 to 10, preferably 1 to 5 and very preferably 2 to 3 carbon atoms. Such groups include, in particular, linear or branched, aliphatic or cycloaliphatic radicals, such as, for example, a methylene, ethylene, propylene, isopropylene, n-butylene, isobutylene, tert-butylene or cyclohexylene group, the ethylene group being particularly preferred.

The group R¹ in formula (I) is an unsaturated radical having 9 to 25 carbon atoms. These groups encompass, in particular, alkenyl, cycloalkenyl, alkenoxy, cycloalkenoxy, alkenoyl and also heteroaliphatic groups. These groups, furthermore, may contain substituents, especially halogen atoms or hydroxy groups. The preferred groups include, in particular, alkenyl groups, such as, for example, the nonenyl, decenyl, undecenyl, dodecenyl, tridecenyl, tetradecenyl, pentadecenyl, hexadecenyl, heptadecenyl, octadecenyl, nonadecenyl, eicosenyl, heneicosenyl, docosenyl, octan-dien-yl, nonan-dien-yl, decan-dien-yl, undecan-dien-yl, dodecan-dien-yl, tridecan-dien-yl, tetradecan-dien-yl, pentadecan-dien-yl, hexadecan-dien-yl, heptadecan-dien-yl, octadecan-dien-yl, nonadecan-dien-yl, eicosan-dien-yl, heneicosan-dien-yl, docosan-dien-yl, tricosan-dien-yl and/or heptadecan-trien-yl group.

The preferred monomers A of formula (I) or (III) include, among others, heptadecenyloyloxy-2-ethyl-(meth)acrylamide, heptadecan-dien-yloyloxy-2-ethyl-(meth)acrylamide, heptadecan-trien-yloyloxy-2-ethyl-(meth)acrylamide, heptadecenyloyloxy-2-ethyl-(meth)acrylamide, (meth)acryloyloxy-2-ethyl-palmitoleamide, (meth)acryloyloxy-2-ethyl-oleamide, (meth)acryloyloxy-2-ethyl-icosenamide, (meth)acryloyloxy-2-ethyl-cetoleamide, (meth)acryloyloxy-2-ethyl-erucamide, (meth)acryloyloxy-2-ethyl-linoleamide, (meth)acryloyloxy-2-ethyl-linolenamide, (meth)acryloyloxy-2-propyl-palmitoleamide, (meth)acryloyloxy-2-propyl-oleamide, (meth)acryloyloxy-2-propyl-icosenamide, (meth)acryloyloxy-2-propyl-cetoleamide, (meth)acryloyloxy-2-propyl-erucamide, (meth)acryloyloxy-2-propyl-linoleamide and (meth)acryloyloxy-2-propyl-linolenamide.

The notation “(meth)acryl” stands for acrylic and methacrylic radicals, with methacrylic radicals being preferred. Particularly preferred monomers A of formula (I) and (Ill) are methacryloyloxy-2-ethyl-oleamide, methacryloyloxy-2-ethyl-linoleamide and/or methacryloyloxy-2-ethyl-linolenamide.

According to one particular embodiment of the present invention it is possible for the monomers A of formula (I) that are used for preparing the polymer to have an iodine number in the range from 50 to 300 g iodine/100 g, more preferably in the range from 100 to 200 g iodine/100 g.

Particular advantages can be achieved in particular by virtue of at least some of the monomers A of formula (I) that are used for preparing the polymer having precisely one double bond in the unsaturated radical R¹. According to a further aspect of the present invention at least some of the monomers A of formula (I) that are used for preparing the polymer may contain two or more double bonds in the unsaturated radical R¹. It is preferred to use mixtures of the monomers A, it being possible for these mixtures to contain not only monomers A having precisely one double bond in the radical R¹ but also monomers A having two or more double bonds in the radical R¹. In this case the weight ratio of monomers A of formula (I) which contain precisely one double bond in the unsaturated radical R¹ to the monomers A of formula (I) which contain two or more double bonds in the unsaturated radical R¹ can be in the range from 100:1 to 1:10, preferably in the range from 10:1 to 1:5.

The monomers A of formula (I) and (III) can be obtained in particular by multi-stage processes. In a first stage, for example, one or more unsaturated fatty acids or fatty acid esters can be reacted with an amine, such as with ethylenediamine, ethanolamine, propylenediamine or propanolamine, for example, to form an amide. In a second stage the hydroxy group or the amine group of the amide is reacted with a (meth)acrylate, methyl(meth)acrylate for example, to give the monomers of the formula (I) or (III), respectively. Useful pointers to the preparation of these monomers can be found in sources including the example of the present specification. For the preparation of monomers in which X¹ is a group of the formula NR′ in which R′ is hydrogen or a radical having 1 to 6 carbon atoms, and X² is oxygen, it is possible, accordingly, first to react an alkyl(meth)acrylate, methyl(meth)acrylate for example, with one of the aforementioned amines, to give a (meth)acrylamide having a hydroxy group in the alkyl radical, which is subsequently reacted with an unsaturated fatty acid to give monomers of the formula A. Transesterifications of alcohols with (meth)acrylates or the preparation of (meth)acrylamides are set out, furthermore, in CN 1355161, DE 21 29 425, filed on 14 Jun. 1971 at the German Patent Office with the application number P 2129425.7, DE 34 23 443, filed on 26 Jun. 1984 at the German Patent Office with the application number P 3423443.8, or EP-A-0 534 666, filed on 16 Sep. 1992 at the European Patent Office with the application number EP 92308426.3, the reaction conditions described in those publications, and also the catalysts, etc., set out therein being incorporated into the present specification for the purposes of disclosure. Furthermore, these reactions are described in “Synthesis of Acrylic Esters by Transesterification”, J. Haken, 1967.

In this context it is possible to purify intermediates that are obtained, examples being carboxamides containing hydroxy groups in the alkyl radical. According to one particular embodiment of the present invention it is possible for intermediates obtained to be reacted, without costly and inconvenient purification, to give the monomers A according to formula (I).

The preferred unsaturated fatty acids that can be used to prepare the present monomers A of formula (I) include, among others, undecylenic acid, palmitoleic acid, oleic acid, elaidic acid, vaccenic acid, icosenoic acid, cetoleic acid, erucic acid, nervonic acid, linoleic acid, linolenic acid, arachidonic acid, timnodonic acid, clupanodonic acid and/or cervonic acid. These acids may also be used preferably as esters of alcohols having 1 to 4 carbon atoms, in the form for example of ethyl, propyl, butyl and, in particular, methyl esters.

The preferred amines for the reaction of the fatty acid or fatty acid ester include, in particular, ethylenediamine, ethanolamine, propanolamine and propylenediamine.

Advantages not obvious per se for the skilled person can be achieved by means of polymers which are obtained using a monomer mixture that has at least 2%, preferably at least 5% and more preferably at least 10% by weight of monomers A having 17 to 21 carbon atoms in the unsaturated radical R¹, based on the total weight of the monomer mixture.

Besides repeating units derived from at least one of the above-described monomers A it is possible for preferred polymers present in the dispersions of the invention to comprise repeating units which are derived from further monomers.

Preferred polymers comprise, in particular, repeating units derived from monomers B of the general formula (II)

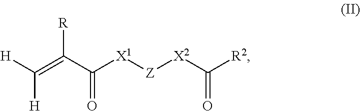

in which R is hydrogen or a methyl group, X¹ and X² independently are oxygen or a group of the formula NR′, in which R′ is hydrogen or a radical having 1 to 6 carbon atoms, with the proviso that at least one of the groups X¹ and X² is a group of the formula NR′ in which R′ is hydrogen or a radical having 1 to 6 carbon atoms, and Z is a linking group, and R² is a saturated radical having 9 to 25 carbon atoms.

For preparing the polymers for inventive use it is possible in this context with preference to employ monomer B of the general formula (IV)

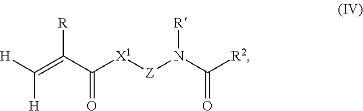

in which R is hydrogen or a methyl group, X¹ is oxygen or a group of the formula NR′ in which R′ is hydrogen or a radical having 1 to 6 carbon atoms, and Z is a linking group, R is hydrogen or a radical having 1 to 6 carbon atoms, and R² is a saturated radical having 9 to 25 carbon atoms.

The groups R′ and Z set out in formula (II) have been described above in connection with the monomers A of formula (I), and so reference will be made to them for the purpose of describing the monomers B of formula (II).

The group R² in formula (II) and (IV) stands for a saturated radical having 9 to 25 carbon atoms. These groups comprise, in particular, alkyl, cycloalkyl, alkoxy, cycloalkoxy, alkanoyl, alkoxycarbonyl groups and also heteroaliphatic groups. Furthermore these groups may contain substituents, especially halogen atoms or hydroxy groups. The preferred groups include, in particular, alkyl groups, such as, for example, the nonyl, decyl, undecyl, dodecyl, tridecyl, tetradecyl, pentadecyl, hexadecyl, heptadecyl, octadecyl, nonadecyl, eicosyl and docosyl group.

The preferred monomers B of formula (II) and (IV) include, among others, pentadecyloyloxy-2-ethyl-(meth)acrylamide, heptadecyloyloxy-2-ethyl-(meth)acrylamide, (meth)acryloyloxy-2-ethyl-lauramide, (meth)acryloyloxy-2-ethyl-myristamide, (meth)acryloyloxy-2-ethyl-palmitamide, (meth)acryloyloxy-2-ethyl-stearamide, (meth)acryloyloxy-2-propyl-lauramide, (meth)acryloyloxy-2-propyl-myristamide, (meth)acryloyloxy-2-propyl-palmitamide and (meth)acryloyloxy-2-propyl-stearamide.

Particularly preferred monomers B of formula (II) and (IV) include methacryloyloxy-2-ethyl-palmitamide and methacryloyloxy-2-ethyl-stearamide.

According to one particular modification of the present invention it is preferred, for preparing the polymers for inventive use, to use monomers B of formula (II) which have 15 or 17 carbon atoms in the radical R².

It is preferred to use 2 or more monomers B of the formula (II) that are used for preparing the polymer in the monomer mixture that differ in the number of carbon atoms in the radical R². Preference is given here to mixtures which contain monomers B of formula (II) having both 15 and 17 carbon atoms in the radical R². The weight ratio of monomers B of formula (II) that contain 15 carbon atoms in the saturated radical R² to monomers B of formula (II) that contain 17 carbon atoms in the saturated radical R² is preferably situated in the range from 100:1 to 1:10, more preferably in the range from 10:1 to 1:2.

In one particular embodiment of the present invention the polymers can be prepared using a monomer mixture which contains at least 0.5%, preferably at least 1% by weight, and with particular preference at least 3% by weight, of monomers B having 11 to 17 carbon atoms in the saturated radical R², based on the total weight of the monomer mixture.

Monomers B of the formula (II) can be prepared in a similar way to the above-described monomers A of the formula (I), but using saturated fatty acids or fatty acid esters. The preferred fatty acids include, among others, capric acid, lauric acid, myristic acid, palmitic acid, margaric acid, arachidic acid, behenic acid, lignoceric acid, cerotic acid and stearic acid. These acids can preferably also be used in the form of esters of alcohols having 1 to 4 carbon atoms, in the form for example of ethyl, propyl, butyl and, in particular, methyl esters.

Monomer mixtures which comprise monomers A of formula (I) and monomers B of formula (II) can be obtained by mixing monomers A and monomers B. Preferably it is possible for these mixtures additionally to be obtained by reacting a fatty acid mixture or fatty acid ester mixture comprising unsaturated and saturated fatty acids and/or fatty acid esters, in the manner set out above, with an amine and subsequently with a (meth)acrylate or with a (meth)acrylamide having a hydroxy group in the alkyl radical.

Preferred polymers can be obtained by means of a monomer mixture which besides the monomer A also comprises monomers B. The weight ratio of the monomers A to the monomers B is not critical per se. Surprising advantages can be obtained, however, if the weight ratio of the monomers A to the monomers B is situated in the range from 100:1 to 1:10, preferably in the range from 10:1 to 1:3 and more preferably in the range from 3:1 to 1:1.

Besides the above-described monomers of the formulae (I) and (II), a monomer mixture for preparing the polymers for inventive use may contain further monomers which are copolymerizable with the monomers A and B.

These copolymerizable monomers include monomers with an acid group, monomers C comprising ester groups, which are different from the monomers of the formulae I or II, and styrene monomers.

Monomers containing acid groups are compounds which can be copolymerized preferably free-radically with the above-described monomers A and B. They include, for example, monomers with a sulphonic acid group, such as vinylsulphonic acid; monomers with a phosphonic acid group, such as vinylphosphonic acid; and unsaturated carboxylic acids, such as methacrylic acid, acrylic acid, fumaric acid and maleic acid, for example. Methacrylic acid and acrylic acid are particularly preferred. The monomers containing acid groups may be used individually or as a mixture of two, three or more monomers containing acid groups.

The preferred monomers C comprising ester groups include, in particular, (meth)acrylates which differ from the monomers A or B, fumarates, maleates and/or vinyl acetate. The expression (meth)acrylates embraces methacrylates and acrylates and also mixtures of both. These monomers are widely known.

These monomers include, more particularly, (meth)acrylates having 1 to 6 carbons in the alkyl radical and deriving from saturated alcohols, such as methyl(meth)acrylate, ethyl(meth)acrylate, n-propyl(meth)acrylate, isopropyl (meth)acrylate, n-butyl(meth)acrylate, tert-butyl(meth)acrylate and pentyl (meth)acrylate, hexyl(meth)acrylate;

cycloalkyl(meth)acrylates, such as cyclopentyl (meth)acrylate, cyclohexyl(meth)acrylate; and

(meth)acrylates deriving from unsaturated alcohols, such as 2-propynyl (meth)acrylate, allyl(meth)acrylate and vinyl(meth)acrylate.

Particular preference is given to using mixtures comprising methacrylates and acrylates. Thus it is possible more particularly to use mixtures of methyl methacrylate and acrylates having 2 to 6 carbons, such as ethyl acrylate, butyl acrylate and hexyl acrylate.

In addition they include, for example, (meth)acrylates having at least 7 carbon atoms in the alkyl radical and deriving from saturated alcohols, such as, for example, 2-ethylhexyl(meth)acrylate, heptyl(meth)acrylate, 2-tert-butylheptyl(meth)acrylate, octyl(meth)acrylate, 3-isopropylheptyl(meth)acrylate, nonyl(meth)acrylate, decyl(meth)acrylate, undecyl(meth)acrylate, 5-methylundecyl(meth)acrylate, dodecyl(meth)acrylate, 2-methyldodecyl(meth)acrylate, tridecyl(meth)acrylate, 5-methyltridecyl(meth)acrylate, tetradecyl(meth)acrylate, pentadecyl(meth)acrylate, hexadecyl(meth)acrylate, 2-methylhexadecyl(meth)acrylate, heptadecyl(meth)acrylate, 5-isopropylheptadecyl(meth)acrylate, 4-tert-butyloctadecyl(meth)acrylate, 5-ethyloctadecyl(meth)acrylate, 3-isopropyloctadecyl(meth)acrylate, octadecyl(meth)acrylate, nonadecyl(meth)acrylate, eicosyl(meth)acrylate, cetyleicosyl(meth)acrylate, stearyleicosyl(meth)acrylate, docosyl(meth)acrylate and/or eicosyltetratriacontyl(meth)acrylate; cycloalkyl(meth)acrylates, such as 3-vinylcyclohexyl(meth)acrylate, bornyl(meth)acrylate, cycloalkyl(meth)acrylates, such as 2,4,5-tri-t-butyl-3-vinylcyclohexyl(meth)acrylate, 2,3,4,5-tetra-t-butylcyclohexyl(meth)acrylate; heterocyclic(meth)acrylates, such as 2-(1-imidazolyl)ethyl(meth)acrylate, 2-(4-morpholinyl)ethyl(meth)acrylate and 1-(2-methacryloyloxyethyl)-2-pyrrolidone; nitriles of(meth)acrylic acid and other nitrogen-containing methacrylates, such as N-(methacryloyloxyethyl)diisobutylketimine, N-(methacryloyloxyethyl)dihexadecylketimine, methacryloylamidoacetonitrile, 2-methacryloyloxyethylmethylcyanamide, cyanomethyl methacrylate; aryl(meth)acrylates, such as benzyl(meth)acrylate or phenyl(meth)acrylate, it being possible for each of the aryl radicals to be unsubstituted or to be substituted up to four times; (meth)acrylates which contain two or more (meth)acrylic groups, glycol di(meth)acrylates, such as ethylene glycol di(meth)acrylate, diethylene glycol di(meth)acrylate, triethylene glycol di(meth)acrylate, tetra- and polyethylene glycol di(meth)acrylate, 1,3-butanediol (meth)acrylate, 1,4-butanediol(meth)acrylate, 1,6-hexanediol di(meth)acrylate, glycerol di(meth)acrylate; dimethacrylates of ethoxylated bisphenol A; (meth)acrylates having three or more double bonds, such as glycerol tri(meth)acrylate, trimethylolpropane tri(meth)acrylate, pentaerythritol tetra(meth)acrylate and dipentaerythritol penta(meth)acrylate.

The monomers C comprising ester groups additionally include vinyl esters, such as vinyl acetate; maleic acid derivatives such as, for example, maleic anhydride, esters of maleic acid, for example dimethyl maleate, methylmaleic anhydride; and fumaric acid derivatives, such as dimethyl fumarate.

A further preferred group of comonomers are styrene monomers, such as, for example, styrene, substituted styrenes having an alkyl substituent in the side chain, such as, for example, α-methylstyrene and α-ethylstyrene, substituted styrenes having an alkyl substituent on the ring, such as vinyltoluene and p-methylstyrene, and halogenated styrenes, such as monochlorostyrenes, dichlorostyrenes, tribromostyrenes and tetrabromostyrenes, for example.

Besides the monomers described above it is possible for inventive polymers 2)) obtained by the polymerization of monomer mixtures to contain further monomers. These include, for example, heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles; maleimide, methyl maleimide;

vinyl ethers and isoprenyl ethers; and

vinyl halides, such as vinyl chloride, vinyl fluoride, vinylidene chloride and

vinylidene fluoride, for example.

Preferred monomer mixtures for preparing the polymers for inventive use comprise

0.1% to 100%, preferably 0.5% to 50%, and more preferably 1% to 30% by weight of monomer A;

0% to 50% by weight, preferably 0.5% to 30% by weight, of monomer B;

0% to 99%, preferably 30% to 95% and more preferably 40% to 90% by weight of monomers with ester groups C;

0% to 10% by weight, preferably 1% to 8% by weight, of monomer with an acid group;

0% to 50% by weight of styrene monomers; and

0% to 50% by weight of further comonomers, the figures being based in each case on the total weight of the monomers.

The iodine number of the polymers for inventive use is preferably in the range from 1 to 150 g iodine per 100 g polymer, more preferably in the range from 2 to 100 g iodine per 100 g polymer and very preferably 5 to 40 g iodine per 100 g polymer, measured in accordance with DIN 53241-1. The iodine number may be measured more particularly on the basis of a dispersion of the invention.

Judiciously the polymer for inventive use may have an acid number in the range from 0.1 to 40 mg KOH/g, preferably 1 to 20 mg KOH/g and very preferably in the range from 2 to 10 mg KOH/g. The acid number may be determined in accordance with DIN EN ISO 2114 from a dispersion as well.

The hydroxy number of the polymer for inventive use can be situated preferably in the range from 0 to 200 mg KOH/g, more preferably 1 to 100 mg KOH/g and very preferably in the range from 3 to 50 mg KOH/g. The hydroxy number may be determined in accordance with DIN EN ISO 4629 from a dispersion as well.

Preferably the polymer for inventive use can have a fraction of 2% to 60%, more preferably 10% to 50% and very preferably 20% to 40%, by weight, based on the weight of the emulsion polymer, which is soluble in tetrahydrofuran (THF) at 20° C. To determine the soluble fraction, a sample of the polymer that has been dried in the absence of oxygen is stored in 200 times the amount of solvent, based on the weight of the sample, at 20° C. for 4 h. In order to ensure the absence of oxygen, the sample, for example, can be dried under nitrogen or under reduced pressure. Subsequently the solution is separated, by filtration for example, from the insoluble fraction. After the solvent has been evaporated the weight of the residue is determined. For example, a 0.5 g sample of an emulsion polymer dried under reduced pressure can be stored in 150 ml of THF for 4 hours.

In accordance with one preferred modification of the present invention a polymer for use may exhibit swelling of at least 1000%, more preferably at least 1400% and very preferably at least 1600% in tetrahydrofuran (THF) at 20° C. The upper limit on the swelling is not critical per se, the swelling preferably being not more than 5000%, more preferably not more than 3000% and very preferably not more than 2500%. To determine the swelling, a sample of the emulsion polymer that has been dried in the absence of oxygen is stored in 200 times the amount of THF at 20° C. for 4 hours. As a result the sample swells. The swollen sample is separated from the supernatant solvent. Subsequently the solvent is removed from the sample. For example, a major fraction of the solvent can be evaporated at room temperature (20° C.). Solvent residues can be removed in a drying oven (140° C.), generally over the course of 1 hour. From the weight of the solvent absorbed by the sample and the weight of the dry sample the swelling is obtained. Furthermore, the difference in the weight of the sample prior to the swelling experiment and the weight of the dried sample after the swelling experiment produces the soluble fraction of the emulsion polymer.

The particle radius of the polymers for inventive use can be situated within a wide range. Thus it is possible in particular to use emulsion polymers having a particle radius in the range from 1 to 500 nm, preferably 1 to 100 nm, more preferably 5 to 59 nm. In accordance with one further aspect of the present invention the radius of the particles is situated preferably in the range from 60 nm to 500 nm, more preferably 70 to 150 nm and very preferably 75 to 100 nm. The radius of the particles can be determined by means of PCS (Photon Correlation Spectroscopy), the data given relating to the d50 value (50% of the particles are smaller, 50% are larger). This can be done using, for example, a Beckman Coulter N5 Submicron Particle Size Analyzer.

The glass transition temperature of the polymer is situated preferably in the range from −30° C. to 70° C., more preferably in the range from −20 to 40° C. and very preferably in the range from 0 to 25° C. The glass transition temperature may be influenced via the nature and the fraction of the monomers used to prepare the polymer. The glass transition temperature, Tg, of the addition polymer may be determined in a known way by means of Differential Scanning calorimetry (DSC). Moreover, the glass transition temperature Tg may also be calculated approximately in advance by means of the Fox equation. According to Fox T. G., Bull. Am. Physics Soc. 1, 3, page 123 (1956) it is the case that

$$\frac{1}{Tg} = \frac{{x}_{1}}{{Tg}_{1}} + \frac{{x}_{2}}{{Tg}_{2}} + … + \frac{{x}_{n}}{{Tg}_{n}}$$

where xₙ represents the mass fraction (% by weight/100) of the monomer n and Tgₙ identifies the glass transition temperature, in kelvins, of the homopolymer of the monomer n. Further useful information can be found by the skilled person in the Polymer Handbook, 2nd Edition, J. Wiley & Sons, New York (1975), which gives Tg values for the most common homopolymers. In this context the polymer may have one or more different glass transition temperatures. These figures therefore apply to a segment which is obtainable by polymerization of a monomer mixture of the invention.

For many applications and properties the architecture of the polymer is not critical. The polymers, especially the emulsion polymers, may accordingly comprise random copolymers, gradient copolymers, block copolymers and/or graft copolymers. Block copolymers and gradient copolymers can be obtained, for example, by discontinuously altering the monomer composition during chain propagation. In accordance with one preferred aspect of the present invention the emulsion polymer is a random copolymer in which the monomer composition over the polymerization is substantially constant. Since, however, the monomers may have different copolymerization parameters, the precise composition may fluctuate over the polymer chain of the polymer.

The polymer, preferably the emulsion polymer, may constitute a homogeneous polymer which, for example, in an aqueous dispersion forms particles having a consistent composition. In this case the emulsion polymer may for example be composed of one or more segments which are obtainable by polymerizing the above-recited monomers or monomer mixtures.

In accordance with another embodiment the polymer may comprise two or more segments. For example, it is possible to use an emulsion polymer with a core-shell structure, which may have one, two, three or more shells. In this case the segment obtainable by polymerizing the above monomer mixture preferably forms the outermost shell of the core-shell polymer. The shell may be connected to the core or to the inner shells by covalent bonds. Moreover, the shell may also be polymerized onto the core or onto an inner shell. In this embodiment the segment obtainable by polymerizing the above monomers or monomer mixtures may in many cases be separated and isolated from the core by means of suitable solvents.

The weight ratio of segment obtainable by polymerizing the above monomer mixture to core may be situated preferably in the range from 2:1 to 1:6, more preferably 1:1 to 1:3.

The core may be formed preferably of polymers comprising 50% to 100%, preferably 60% to 90%, by weight of units derived from (meth)acrylates. Preference here is given to esters of (meth)acrylic acid whose alcohol residue comprises preferably 1 to 30 carbon atoms, more preferably 1 to 20 carbon atoms and very preferably 1 to 10 carbon atoms. Such (meth)acrylates include, more particularly, (meth)acrylates deriving from saturated alcohols, such as methyl(meth)acrylate, ethyl(meth)acrylate, n-propyl(meth)acrylate, isopropyl(meth)acrylate, n-butyl(meth)acrylate, tert-butyl(meth)acrylate, pentyl(meth)acrylate and hexyl(meth)acrylate.

In accordance with one particular embodiment of the present invention the core can be prepared using a mixture which comprises methacrylates and acrylates. Thus it is possible more particularly to use mixtures of methyl methacrylate and acrylates having 2 to 6 carbons, such as ethyl acrylate, butyl acrylate and hexyl acrylate.

Furthermore, the polymers of the core may comprise the comonomers set out above. In accordance with one preferred modification the core may be crosslinked. This crosslinking may be achieved through the use of monomers having two, three or more free-radically polymerizable double bonds.

The shell of emulsion polymers whose use is preferred may comprise preferably 15% to 50% by weight of units derived from monomers A of formula (I) which in the radical R¹ have at least one double bond.

In accordance with one particular aspect the core may preferably have a glass transition temperature in the range from -30 to 200° C., more preferably in the range from -20 to 150° C. The shell may preferably have a glass transition temperature in the range from -30° C. to 70° C., more preferably in the range from −20 to 40° C. and very preferably in the range from 0 to 25° C. In accordance with one particular aspect of the present invention the glass transition temperature of the core may be greater than the glass transition temperature of the shell. Judiciously the glass transition temperature of the core may be at least 10° C., preferably at least 20° C., above the glass transition temperature of the shell.

The polymers described above comprising repeating units derived from monomers A of formula (I) may be prepared in a known way, as for example by solution, bulk or emulsion polymerization, with the use of variants of these polymerization processes being possible as well, such as, for example, ATRP (Atom Transfer Radical Polymerization), NMP (Nitroxide Mediated Polymerization) or RAFT (Reversible Addition Fragmentation Chain Transfer) processes. The polymerization is preferably carried out as an emulsion polymerization.

Emulsion polymerization processes are set out in sources including Ullmann's Encyclopedia of Industrial Chemistry, Fifth Edition. For these processes, the general approach is to prepare an aqueous phase which as well as water may include typical additives, more particularly emulsifiers and protective colloids for stabilizing the emulsion.

This aqueous phase is then admixed with monomers, and polymerization is carried out in the aqueous phase. When preparing homogeneous polymer particles, it is possible here to add a monomer mixture batchwise or continuously over a time interval.

The emulsion polymerization may be performed, for example, as a miniemulsion or as a microemulsion. These are set out in more detail in Chemistry and Technology of Emulsion Polymerisation, A.M. van Herk (editor), Blackwell Publishing, Oxford 2005 and J. O'Donnell, E. W. Kaler, Macromolecular Rapid Communications 2007, 28(14), 1445-1454. A miniemulsion is normally characterized by the use of costabilizers or swelling agents, and long-chain alkanes or alkanols are often used. The droplet size in the case of miniemulsions is situated preferably in the range from 0.05 to 20 μm. The droplet size in the case of microemulsions is situated preferably in the range below 1 μm, allowing particles to be obtained below a size of 50 nm. In the case of microemulsions it is common to use additional surfactants, examples being hexanol or similar compounds.

The dispersing of the monomer phase in the aqueous phase can take place using known agents. These include, more particularly, mechanical methods and also the application of ultrasound.

In the preparation of homogeneous emulsion polymers it is possible with preference to use a monomer mixture which comprises 10% to 40% by weight of monomers A of formula (I).

When preparing core-shell polymers it is possible to change the composition of the monomer mixture in steps, polymerization preferably taking place, before the composition is changed, to a conversion of at least 80% by weight, more preferably at least 95% by weight, based in each case on the total weight of the monomer mixture used. The progress of the polymerization reaction in each step can be monitored in a known way, such as by gravimetry or gas chromatography, for example.

The monomer mixture for preparing the core comprises preferably 50% to 100% by weight of (meth)acrylates, particular preference being given to the use of a mixture of acrylates and methacrylates. After the core has been prepared, it is possible to graft or to polymerize onto the core, preferably, a monomer mixture which comprises 15% to 40% by weight of monomers A of formula (I).

The emulsion polymerization is conducted preferably at a temperature in the range from 0 to 120° C., more preferably in the range from 30 to 100° C. Polymerization temperatures which have proved to be especially favourable in this context are temperatures in the range from greater than 60 to less than 90° C., judiciously in the range from greater than 70 to less than 85° C., preferably in the range from greater than 75 to less than 85° C.

The polymerization is initiated with the initiators that are customary for emulsion polymerization. Suitable organic initiators are, for example, hydroperoxides such as tert-butyl hydroperoxide or cumene hydroperoxide. Suitable inorganic initiators are hydrogen peroxide and also the alkali metal salts and the ammonium salts of peroxodisulphuric acid, more particularly ammonium, sodium and potassium peroxodisulphate. Suitable redox initiator systems are, for example, combinations of tertiary amines with peroxides or sodium disulphite and alkali metal salts and the ammonium salts of peroxodisulphuric acid, more particularly sodium and potassium peroxodisulphate. Further details can be taken from the technical literature, more particularly H. Rauch-Puntigam, Th. Völker, “Acryl- and Methacrylverbindungen”, Springer, Heidelberg, 1967 or Kirk-Othmer, Encyclopaedia of Chemical Technology, Vol. 1, pages 386ff, J. Wiley, New York, 1978. Particular preference in the context of the present invention is given to the use of organic and/or inorganic initiators.

The stated initiators may be used both individually and in a mixture. They are preferably used in an amount of 0.05% to 3.0% by weight, based on the total weight of the monomers of the respective stage. It is also possible with preference to carry out the polymerization with a mixture of different polymerization initiators having different half-lives, in order to keep the flow of free radicals constant over the course of the polymerization and also at different polymerization temperatures.

Stabilization of the batch is accomplished preferably by means of emulsifiers and/or protective colloids. The emulsion is preferably stabilized by emulsifiers, in order to obtain a low dispersion viscosity. The total amount of emulsifier is preferably 0.1% to 15% by weight, more particularly 1% to 10% by weight and more preferably 2% to 5% by weight, based on the total weight of the monomers used. In accordance with one particular aspect of the present invention it is possible to add a portion of the emulsifiers during the polymerization.

Particularly suitable emulsifiers are anionic or nonionic emulsifiers or mixtures thereof, more particularly
alkyl sulphates, preferably those having 8 to 18 carbon atoms in the alkyl radical, alkyl and alkylaryl ether sulphates having 8 to 18 carbon atoms in the alkyl radical and 1 to 50 ethylene oxide units;
sulphonates, preferably alkylsulphonates having 8 to 18 carbon atoms in the alkyl radical, alkylarylsulphonates having 8 to 18 carbon atoms in the alkyl radical, esters and monoesters of sulphosuccinic acid with monohydric alcohols or alkylphenols having 4 to 15 carbon atoms in the alkyl radical; where appropriate these alcohols or alkylphenols may also have been ethoxylated with 1 to 40 ethylene oxide units;
phosphoric acid partial esters and their alkali metal and ammonium salts, preferably alkyl and alkylaryl phosphates having 8 to 20 carbon atoms in the alkyl or alkylaryl radical and 1 to 5 ethylene oxide units;
alkyl polyglycol ethers, preferably having 8 to 20 carbon atoms in the alkyl radical and 8 to 40 ethylene oxide units;
alkylaryl polyglycol ethers, preferably having 8 to 20 carbon atoms in the alkyl or alkylaryl radical and 8 to 40 ethylene oxide units;
ethylene oxide/propylene oxide copolymers, preferably block copolymers, favourably having 8 to 40 ethylene and/or propylene oxide units.

The particularly preferred anionic emulsifiers include, more particularly, fatty alcohol ether sulphates, diisooctyl sulphosuccinate, lauryl sulphate, C15-paraffinsulphonate, it being possible to use these compounds generally in the form of the alkali metal salt, more particularly the sodium salt. These compounds may be obtained commercially, more particularly, under the commercial designations Disponil® FES 32, Aerosol® OT 75, Texapon® K1296 and Statexan® K1 from the companies Cognis GmbH, Cytec Industries, Inc. and Bayer AG.

Judicious nonionic emulsifiers include tert-octylphenol ethoxylate with 30 ethylene oxide units and fatty alcohol polyethylene glycol ethers which have preferably 8 to 20 carbon atoms in the alkyl radical and 8 to 40 ethylene oxide units. These emulsifiers are available commercially under the commercial designations Triton® X 305 (Fluka), Tergitol® 15-S-7 (Sigma-Aldrich Co.), Marlipal® 1618/25 (Sasol Germany) and Marlipal® O 13/400 (Sasol Germany).

With preference it is possible to use mixtures of anionic emulsifier and nonionic emulsifier. The weight ratio of anionic emulsifier to nonionic emulsifier can judiciously be in the range from 20:1 to 1:20, preferably 2:1 to 1:10 and more preferably 1:1 to 1:5. Mixtures which have proven to be especially appropriate are those comprising a sulphate, more particularly a fatty alcohol ether sulphate, a lauryl sulphate, or a sulphonate, more particularly a diisooctyl sulphosuccinate or a paraffin sulphonate, as anionic emulsifier, and an alkylphenol ethoxylate or a fatty alcohol polyethylene glycol ether having in each case preferably 8 to 20 carbon atoms in the alkyl radical and 8 to 40 ethylene oxide units, as nonionic emulsifier.

Where appropriate the emulsifiers can also be used in a mixture with protective colloids. Suitable protective colloids include partially hydrolysed polyvinyl acetates, polyvinylpyrrolidones, carboxymethyl-, methyl-, hydroxyethyl- and hydroxypropyl-cellulose, starches, proteins, poly(meth)acrylic acid, poly(meth)acrylamide, polyvinylsulphonic acids, melamine-formaldehyde sulphonates, naphthalene-formaldehyde sulphonates, styrene-maleic acid and vinyl ether-maleic acid copolymers. If protective colloids are used they are used preferably in an amount of 0.01% to 1.0% by weight, based on the total amount of the monomers. The protective colloids may be included in the initial charge before the start of the polymerization, or metered in. The initiator may be included in the initial charge or metered in. It is also possible, furthermore, to include a portion of the initiator in the initial charge and to meter in the remainder.

The polymerization is preferably started by heating the batch to the polymerization temperature and metering in the initiator, preferably in aqueous solution. The metered feeds of emulsifier and monomers may be carried out separately or as a mixture. In the case of the metered addition of mixtures of emulsifier and monomer, the approach taken is to premix emulsifier and monomer in a mixer upstream of the polymerization reactor. Preferably the remainders of emulsifier and of monomer which have not been included in the initial charge are metered in separately from one another after the start of the polymerization. With preference it is possible to commence the metered feed 15 to 35 minutes after the start of the polymerization.

Emulsion polymers whose use is preferred, and with a high fraction of insoluble polymers, can be obtained in the manner set out above, the reaction parameters for obtaining a high molecular weight being known. Thus it is possible more particularly in this context to omit the use of molecular weight regulators.

One of the ways in which the adjustment of the particle radii can be influenced is via the fraction of emulsifiers. The higher this fraction, more particularly at the beginning of the polymerization, the smaller the particles obtained.

For preparing the aqueous dispersions of the invention, an aqueous alkyd resin can be mixed with the polymer set out above. Furthermore, it is also possible to introduce to start with an alkyd resin dispersion, in which, subsequently, a polymer comprising repeating units derived from monomers A of formula (I) is prepared.

In this case at least some of the polymers comprising repeating units derived from monomers A of formula (I) can be bonded covalently to the alkyd resin. According to a further aspect of the present invention, at least some of the polymers comprising repeating units derived from monomers A of formula (I) can be bonded non-covalently to the alkyd resin. A covalent bond between polymer and alkyd resin can be achieved through the use of alkyd resins which have free-radically polymerizable double bonds. For example, (meth)acrylic acid or the compounds set out above can be used for introducing pendent and/or terminal allyloxy groups during the preparation of the alkyd resin, in order to achieve this.

Following preparation of the alkyd resin it is possible, for example, to react a composition which comprises at least one monomer A of formula (I). In this case the monomer A may be grafted onto the alkyd resin or polymerized in the form of a shell onto part of the alkyd resin. Furthermore it is also possible first to prepare a polymer which comprises monomers A of formula (I). In a dispersion containing this polymer it is possible subsequently to prepare an alkyd resin. In an aqueous dispersion a reaction of the monomers A can be brought about in particular by means of water-soluble initiators, which were set out above. Useful information concerning the reaction of monomers with alkyd resins can be found in sources including US 5,538,760, US 6,369,135 and DE-A-199 57 161.

The weight fractions of alkyd resin and polymers comprising repeating units derived from monomers A of formula (I) may be situated within a wide range, which may generally be adapted to the desired profile of properties. Preferably the weight ratio of alkyd resin to polymers comprising repeating units derived from monomers A of formula (I) is situated in the range from 20:1 to 1:20, more preferably 5:1 to 1:5 and very preferably 3:1 to 1:3, based on the dry weight of the respective components. In the case of dispersions with a fraction of polymer which is bonded covalently to the alkyd resin, these figures relate to the fractions of the respective compounds that are used for preparing the dispersion.

The aqueous dispersions obtained by the process of the invention can be used as coating materials. The aqueous dispersions preferably have a solids content in the range from 10% to 70% by weight, more preferably 20% to 60% by weight.

To prepare a dispersion of the invention it is possible with preference to use a polymer dispersion which has a dynamic viscosity within the range from 0.1 to 180 mPas, preferably 1 to 80 mPas, and very preferably 10 to 50 mPas, measured in accordance with DIN EN ISO 2555 at 25° C. (Brookfield).

Besides water and the polymers comprising repeating units derived from monomers A of formula (I) and alkyd resins set out above, the dispersions of the invention may include additives or further components for adapting the properties of the coating material to specific requirements. These additional substances include, more particularly, drying assistants, known as siccatives, and flow improvers, pigments and dyes.

The coating materials of the invention do not need siccatives, but the latter may be present as an optional constituent in the compositions. With particular preference it is possible to add siccatives to the aqueous dispersions. These siccatives include, more particularly, organometallic compounds, examples being metal soaps of transition metals, such as cobalt, manganese, lead and zirconium, for example; alkali metals or alkaline earth metals, such as lithium, potassium and calcium, for example. Examples that may be mentioned include cobalt naphthalate and cobalt acetate. The siccatives can be used individually or as a mixture, in which case particular preference is given more particularly to mixtures which comprise cobalt salts, zirconium salts and lithium salts.

The coating materials of the invention preferably have a minimum film formation temperature of not more than 50° C., with particular preference not more than 35° C. and with very particular preference not more than 25° C., a temperature which can be measured in accordance with DIN ISO 2115.

In accordance with one preferred aspect of the present invention it is possible for an aqueous dispersion of the invention to have an iodine number according to DIN 53241 of at least 1 g iodine/100 g, preferably of at least 10 g iodine/100 g, more preferably of at least 15 g iodine/100 g. In accordance with to one particular aspect of the present invention the iodine number of the aqueous dispersion may be situated in the range from 2 to 100 g iodine per 100 g aqueous dispersion, more preferably 15 to 50 g iodine per 100 g aqueous dispersion. The iodine number may be determined from a dispersion, the figure being based on the solids content.

The aqueous dispersion may judiciously have an acid number in the range from 0.1 to 100 mg KOH/g, preferably 1 to 40 mg KOH/g and very preferably in the range from 2 to 10 mg KOH/g. The acid number may be determined in accordance with DIN EN ISO 2114 from a dispersion, the figure being based on the solids content.

The hydroxy number of an aqueous dispersion of the invention may be situated preferably in the range from 0 to 400 mg KOH/g, more preferably 1 to 200 mg KOH/g and very preferably in the range from 3 to 150 mg KOH/g. The hydroxy number can be determined in accordance with DIN EN ISO 4629 from a dispersion, the figure being based on the solids content.

The aqueous dispersions of the present invention can be used more particularly as coating materials or as additives for them. Such materials include, more particularly, paints and varnishes, impregnating compositions, adhesives and/or primer systems. With particular preference the aqueous dispersions can be employed for producing paints, varnishes or impregnating compositions for applications on wood and/or metal.

The coatings obtainable from the coating materials of the invention exhibit high solvent resistance; more particularly, only small fractions are dissolved from the coating by solvents. Preferred coatings exhibit a high resistance, more particularly, to methyl isobutyl ketone (MIBK). Hence the weight loss after treatment with MIBK amounts preferably to not more than 50% by weight, more preferably not more than 35% by weight. The absorption of MIBK amounts preferably to not more than 300% by weight, with particular preference not more than 250% by weight, based on the weight of the coating used. These values are measured at a temperature of approximately 25° C. over an exposure time of at least 4 hours, the coating subjected to measurement being a fully dried coating. This drying takes place in the presence of oxygen, air for example, in order to allow crosslinking.

The coatings obtained from the coating materials of the invention display a high mechanical stability. The pendulum hardness is preferably at least 15 s, more preferably at least 25 s, measured in accordance with DIN ISO 1522.

The present invention will be illustrated in greater detail below with reference to inventive and comparative examples, without any intention thereby to restrict the invention.

### INVENTIVE EXAMPLE 1

### PREPARATION OF THE METHACRYLOYLOXY-2-ETHYL-FATTY ACID AMIDE MIXTURE EMPLOYED

A four-necked round-bottomed flask equipped with a sabre stirrer with stirring jacket and stirring motor, nitrogen inlet, liquid-phase thermometer and a distillation bridge was charged with 206.3 g (0.70 mol) of fatty acid methyl ester mixture, 42.8 g (0.70 mol) of ethanolamine and 0.27 g (0.26%) of LiOH. The fatty acid methyl ester mixture comprised 6% by weight saturated C12 to C16 fatty acid methyl esters, 2.5% by weight saturated C17 to C20 fatty acid methyl esters, 52% by weight monounsaturated C18 fatty acid methyl esters, 1.5% by weight monounsaturated C20 to C24 fatty acid methyl esters, 36% by weight polyunsaturated C18 fatty acid methyl esters and 2% by weight polyunsaturated C20 to C24 fatty acid methyl esters.

The reaction mixture was heated to 150° C. Over the course of 2 h 19.5 ml of methanol were removed by distillation. The resulting reaction product contained 86.5% of fatty acid ethanolamides. The reaction mixture obtained was processed further without purification.

After cooling had taken place, 1919 g (19.2 mol) of methyl methacrylate, 3.1 g of LiOH and an inhibitor mixture consisting of 500 ppm of hydroquinone monomethyl ether and 500 ppm of phenothiazine were added.

With stirring, the reaction apparatus was flushed with nitrogen for 10 minutes. Thereafter the reaction mixture was heated to boiling. The methyl methacrylate/methanol azeotrope was separated off and then the overhead temperature was raised in steps to 100° C. After the end of the reaction the reaction mixture was cooled to approximately 70° C. and filtered.

Excess methyl methacrylate was separated off on a rotary evaporator. This gave 370 g of product.

Preparation of an Inventive Dispersion

Then, in a 2 I PE beaker, 180 g of butyl acrylate (BA), 156 g of methyl methacrylate (MMA), 60 g of methacryloyloxy-2-ethyl-fatty acid amide mixture, 4 g of methacrylic acid (MAA), 1.2 g of ammonium peroxodisulphate (APS), 12.0 g of Disponil FES 32 (30% form) and 359.18 g of water were emulsified using an Ultra-Turrax at 4000 rpm for 3 minutes.

A 2 I glass reactor which had a water bath heating facility and was equipped with a blade stirrer was charged with 230 g of water and 0.3 g of Disponil FES 32 (30% form) and this initial charge was heated to 80° C. and admixed with 0.3 g of ammonium peroxodisulphate (APS) in solution in 10 g of water. 5 minutes after the addition of the APS, the emulsion prepared beforehand was metered in over the course of 240 minutes (interval: 3 minutes' feed, 4 minutes' pause, 237 minutes' feed of remainder).

After the end of the feeds the batch was stirred at 80° C. for 1 hour. Thereafter it was cooled to room temperature and the dispersion was filtered through VA screen fabric of 0.09 mm mesh size.

The emulsion prepared had a solids content of 40±1%, a pH of 5.6, a viscosity of 37 mPas and an r_{N5} value of 70-75 nm.

117.15 g of the aqueous emulsion prepared before were mixed with 33.7 g of a PU alkyd resin (available commercially from Worlee under the designation Worlee E150W)

The properties of the resulting coating material were investigated by a variety of methods. On dried films, experiments relating to the solvent resistance, water absorption and scratch resistance were carried out for this purpose.

The solvent resistance was determined using methyl isobutyl ketone (MIBK), with a sample being swollen with MIBK at room temperature for 4 hours. Thereafter the sample was taken from the solvent and excess solvent was removed. Subsequently the sample was dried at about 140° C. for 1 hour. The fraction of the sample that was removed by the solvent is calculated from the weight loss.

The swelling in ethanol that is indicated in Table 1 was determined in a similar way to the above-described experimental description, but using ethanol as the solvent. The figure is based on the weight of the coating obtained after the test, the weight being lower than the weight of the initial sample as a result of the weight loss.

The water absorption can be determined using a specimen of untreated solid pine (dimensions: 45-50 mm×45-50 mm×17 mm). The specimen was provided with a layer of varnish and placed in water at room temperature, with only the coated surface in contact with the water. The water absorption is calculated from the increase in weight of the specimen. A DIN 68861-1 furniture test was conducted as well.

The scratch resistance was investigated with the pendulum test. The results obtained are given in Table 1.

### INVENTIVE EXAMPLE 2

Inventive Example 1 was essentially repeated, but mixing 66.29 g of the aqueous dispersion prepared in Inventive Example 1 with 57.2 g of a polyurethane alkyd resin (available commercially from Worlée under the designation E150W). On dried films, experiments relating to the solvent resistance, water absorption and scratch resistance were carried out. The results obtained are given in Table 1.

### COMPARATIVE EXAMPLE 1

In a further experiment, the alkyd resin used in Inventive Example 1 was investigated without the addition of the above-described (meth)acrylate-based addition polymer. On dried films, experiments relating to the solvent resistance, water absorption and scratch resistance were carried out. The results obtained are given in Table 1.

### COMPARATIVE EXAMPLE 2

First of all, in a 2 I PE beaker, 216 g of butyl acrylate (BA), 180 g of methyl methacrylate (MMA), 4 g of methacrylic acid (MAA), 1.2 g of ammonium peroxodisulphate (APS), 12.0 g of Disponil FES 32 (30% form) and 359.18 g of water were emulsified using an Ultra-Turrax at 4000 rpm for 3 minutes.

A 2 l glass reactor which had a water bath heating facility and was equipped with a blade stirrer was charged with 230 g of water and 0.3 g of Disponil FES 32 (30% form) and this initial charge was heated to 80° C. and admixed with 0.3 g of ammonium peroxodisulphate (APS) in solution in 10 g of water. 5 minutes after the addition of the APS, the emulsion prepared beforehand was metered in over the course of 240 minutes (interval: 3 minutes' feed, 4 minutes' pause, 237 minutes' feed of remainder).

After the end of the feeds the batch was stirred at 80° C. for 1 hour. Thereafter it was cooled to room temperature and the dispersion was filtered through VA screen fabric of 0.09 mm mesh size.

On dried films, experiments relating to the solvent resistance, water absorption and scratch resistance were carried out. The results obtained are given in Table 1.

### INVENTIVE EXAMPLE 3

Inventive Example 1 was essentially repeated, but mixing 117.15 g of the aqueous dispersion prepared in Inventive Example 1 with 33.7 g of a urethane-modified, cosolvent-free, short-oil alkyd emulsion. On dried films, experiments relating to the solvent resistance, water absorption and scratch resistance were carried out.

In this case, additionally, a furniture test was carried out in accordance with DIN 68861-1. The results obtained are given in Table 1.

### INVENTIVE EXAMPLE 4

Inventive Example 3 was essentially repeated, but mixing 66.29 g of the aqueous dispersion prepared in Inventive Example 1 with 57.2 g of a urethane-modified, cosolvent-free, short-oil alkyd emulsion. On dried films, experiments relating to the solvent resistance, water absorption and scratch resistance were carried out. The results obtained are given in Table 1.

### INVENTIVE EXAMPLE 5

Inventive Example 3 was essentially repeated, but mixing 33.7 g of the aqueous dispersion prepared in Inventive Example 1 with 117.15 g of a urethane-modified, cosolvent-free, short-oil alkyd emulsion. On dried films, experiments relating to the solvent resistance, water absorption and scratch resistance were carried out. The results obtained are given in Table 1.

### COMPARATIVE EXAMPLE 3

In a further experiment, the alkyd resin used in Inventive Example 3 was investigated without the addition of the above-described (meth)acrylate-based addition polymer. On dried films, experiments relating to the solvent resistance, water absorption and scratch resistance were carried out. The results obtained are given in Table 1.

TABLE 1
Results of the investigations of properties

| | Inventive | Inventive | Inventive | Inventive |
|---|---|---|---|---|
| | Example 1 | Example 2 | Example 3 | Example 4 |
| Pendulum hardness | 68.2 | 45.3 | 18.1 | 17.3 |
| [s] | | | | |
| Weight loss in MIBK | 19.7 | 20.3 | 15.2 | 19.4 |
| [%] | | | | |
| Swelling in ethanol [%] | 89 | 97 | 103 | 125 |
| Water absorption after | 8.7% | 10.5% | 7.2% | 9.0 |
| 6 h | | | | |
| Furniture test EtOH | 5 | 5 | 5 | 5 |
| (48%) 1 h | | | | |
| Furniture test HOAc | 5 | 5 | 5 | 5 |
| (15%) 1 h | | | | |
| Furniture test NH₃ | 3 | 3 | 3 | 3 |
| (10%) 1 h | | | | |
| | | Compar- | Compar- | Compar- |
| | Inventive | ative | ative | ative |
| | Example 5 | Example 1 | Example 2 | Example 3 |
| Pendulum hardness | 20.1 | 13.3 | 7 | 12.6 |
| [s] | | | | |
| Weight loss in MIBK | 19.8 | 47.7 | dissolved | 59.0 |
| [%] | | | | |
| Swelling in ethanol [%] | 139 | — | 135 | 281 |
| Water absorption after | 10.9% | 14.0% | 11.2% | 16.9% |
| 6 h | | | | |
| Furniture test EtOH | 5 | — | 1 | 3 |
| (48%) 1 h | | | | |
| Furniture test HOAc | 5 | — | 3 | 3 |
| (15%) 1 h | | | | |
| Furniture test NH₃ | 3 | — | 1 | 2 |
| (10%) 1 h | | | | |

1. An aqueous dispersion, comprising:
at least one alkyd resin; and
at least one polymer comprising repeating units comprising, in reacted form, at least one monomer A of formula (I) 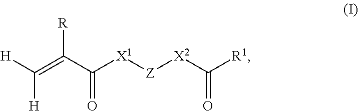
wherein
R is hydrogen or a methyl group;
X¹ and X² independently are oxygen or a group of the formula NR′, in which R′ is hydrogen or a radical having 1 to 6 carbon atoms, with the proviso that at least one of the groups X¹ and X² is a group of the formula NR′ in which R′ is hydrogen or a radical having 1 to 6 carbon atoms;
Z is a linking group; and
R¹ is an unsaturated radical having 9 to 25 carbon atoms.

2. The aqueous dispersion according to claim 1, wherein the alkyd resin is obtained by reacting a polyhydric alcohol with a polyfunctional isocyanate.

3. The aqueous dispersion according to claim 1, wherein the alkyd resin comprises units derived from at least one aromatic dicarboxylic acid.

4. The aqueous dispersion according to claim 1, wherein the alkyd resin comprises units derived from at least one alcohol alcohols having three or more hydroxy groups.

5. The aqueous dispersion according to claim 1, wherein the alkyd resin comprises units derived from at least one fatty acid acids having 6 to 30 carbon atoms.

6. The aqueous dispersion according to claim 5, wherein the alkyd resin comprises units derived from at least one unsaturated fatty acid having 6 to 30 carbon atoms.

7. The aqueous dispersion according to claim 1, wherein the alkyd resin has an iodine number of at least 10 g/100 g.

8. The aqueous dispersion according to claim 1, wherein the alkyd resin has an acid number in a range from 0.1 to 100 mg KOH per g alkyd resin.

9. The aqueous dispersion according to claim 1, wherein the alkyd resin has a hydroxy number in a range from 1 to 200 mg KOH per g alkyd resin.

10. The aqueous dispersion according to claim 1, wherein the alkyd resin is a urethane alkyd resin obtained by reacting at least one polyhydric alcohol A′, at least one modified fatty acid B′, at least one fatty acid C′ and at least one polyfunctional isocyanate D′.

11. The aqueous dispersion according to claim 1, wherein the polymer comprising repeating units derived from at least one monomer A of formula (I) comprises at least 2 repeating units.

12. The aqueous dispersion according to claim 1, wherein the polymer comprising repeating units derived from at least one monomer A of formula (I) comprises repeating units derived from at least one monomer B of formula (II) 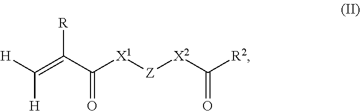
wherein:
R is hydrogen or a methyl group;
X¹ and X² independently are oxygen or a group of the formula NR′, in which R′ is hydrogen or a radical having 1 to 6 carbon atoms, with the proviso that at least one of the groups X¹ and X² is a group of the formula NR’ in which R′ is hydrogen or a radical having 1 to 6 carbon atoms;
Z is a linking group; and
R² is a saturated radical having 9 to 25 carbon atoms.

13. The aqueous dispersion according to claim 1, wherein the polymer comprises repeating units derived from at least one monomer C which comprise ester groups and are different from monomers A and B, wherein monomer B is represented by formula (II) 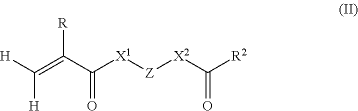
wherein:
R is hydrogen or a methyl group;
X¹ and X² independently are oxygen or a group of the formula NR′, in which R′ is hydrogen or a radical having 1 to 6 carbon atoms, with the proviso that at least one of the groups X¹ and X² is a group of the formula NR′ in which R′ is hydrogen or a radical having 1 to 6 carbon atoms;
Z is a linking group; and
R² is a saturated radical having 9 to 25 carbon atoms.

14. The aqueous dispersion according to claim 1, wherein the polymer comprising repeating units derived from at least one monomer A of formula (I) is obtained by reaction of a monomer mixture which comprises
0.1% to 50% by weight of monomer A,
0.1% to 50% by weight of monomer B,
30% to 95% by weight of monomer C comprising ester groups,
0% to 10% by weight of monomer with an acid group,
0% to 50% by weight of styrene monomers, and
0% to 50% by weight of further comonomers,
wherein monomer B is represented by formula II 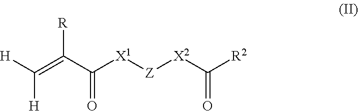
wherein:
R is hydrogen or a methyl group;
X¹ and X² independently are oxygen or a group of the formula NR′, in which R′ is hydrogen or a radical having 1 to 6 carbon atoms, with the proviso that at least one of the groups X¹ and X² is a group of the formula NR′ in which R′ is hydrogen or a radical having 1 to 6 carbon atoms;
Z is a linking group; and
R² is a saturated radical having 9 to 25 carbon atoms.

15. The aqueous dispersion according to claim 1, wherein at least a portion of the at least one polymer are bonded covalently to the alkyd resin.

16. The aqueous dispersion according to claim 1, wherein at least a portion of the at least one polymer are bonded non-covalently to the alkyd resin.

17. The aqueous dispersion according to claim 1, wherein the at least one polymer is an addition polymer having a particle radius in the range from 1 to 500 nm.

18. The aqueous dispersion according to claim 17, wherein the addition polymer comprises at least one (meth)acrylate segment and has a core-shell structure, comprising a core and a shell.

19. The aqueous dispersion according to claim 18, wherein the core comprises 50% to 100% by weight of units comprising, in reacted form, at least one (meth)acrylate.

20. The aqueous dispersion according to claim 1, wherein the at least one polymer has an iodine number in a range from 5 to 40 g/100 g polymer.

21. The aqueous dispersion according to claim 1, having an iodine number in a range from 2 to 100 g/100 g dispersion, based on solids content.

22. The aqueous dispersion according to having an acid number in a range from 0.1 to 100 g/100 g dispersion, based on solids content.

23. The aqueous dispersion according to claim 1, wherein a weight ratio of the alkyd resin to the at least one polymer is in a range from 20:1 to 1:20, based on a dry weight of respective components.

24. A process for preparing an aqueous dispersion according to claim 1, the process comprising:
preparing an aqueous dispersion of a polymer comprising repeating units comprising, in reacted form, at least one monomer A of formula (I), ; and
mixing the aqueous dispersion with an alkyd resin.

25. A process for preparing an aqueous dispersion according to claim 1, the process comprising:
preparing an alkyd resin; and
reacting the alkyd resin with at least one monomer A of formula (I) 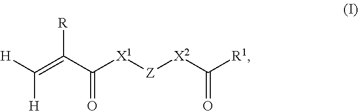
wherein:
R is hydrogen or a methyl group,
X¹ and X² independently are oxygen or a group of the formula NR′, in which R′ is hydrogen or a radical having 1 to 6 carbon atoms, with the proviso that at least one of the groups X¹ and X² is a group of the formula NR′ in which R′ is hydrogen or a radical having 1 to 6 carbon atoms; and
Z is a linking group and
R¹ is an unsaturated radical having 9 to 25 carbon atoms.
